(19) United States
(12) Patent Application Publication
(10) Pub. No.: US 2015/0182908 A1
(43) Pub. Date: Jul. 2, 2015

(54) METHOD OF RECOVERYING A LOW CONCENTRATION GAS USING TWO MEMBRANE STAGES WITH A SECOND STAGE REFLUX

(71) Applicant: L'Air Liquide, Societe Anonyme pour I'Etude et I'Exploitation des Procedes Georges Claude, Paris (FR)

(72) Inventor: Sudhir S. KULKARNI, Wilmington, DE (US)

(73) Assignee: L'Air Liquide, Societe Anonyme pour I'Etude et I'Exploitation des Procedes Georges Claude, Paris (FR)

(21) Appl. No.: 14/144,013

(22) Filed: Dec. 30, 2013

(51) Int. Cl. B01D 53/22

(52) U.S. Cl. CPC B01D 53/22

(57) ABSTRACT

A first gas present at low concentration in a source gas is recovered from the source gas at a relatively high recovery using first and second gas separation membrane stages. The second stage permeate gas is divided into first and second portions. The first portion is a first product gas a majority of which is the first gas. The second portion and the permeate gas from the first stage are both fed to the compressor and then to the second stage gas separation membrane. The second stage non-permeate gas is combined with the source gas and fed to the first gas separation membrane stage. The first gas separation membrane separates that combined gas into the permeate (which is combined with the second portion as explained above) and a non-permeate. The first stage non-permeate is the second product gas mainly comprised of the second gas. The invention is particularly applicable to natural gas containing Helium.

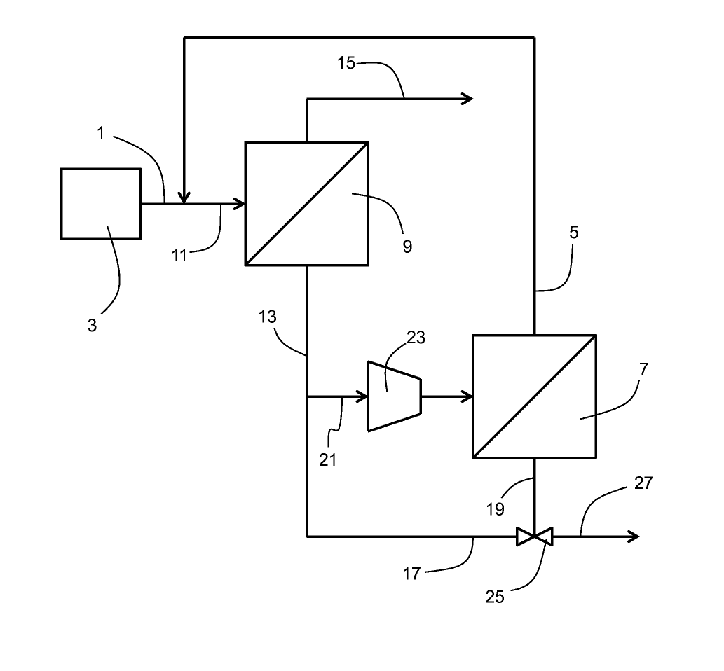

### CROSS-REFERENCE TO RELATED APPLICATIONS

None.

### BACKGROUND

1. Field of the Invention

The present invention relates to membrane separation at relatively high recovery of a gas that is present in a gas mixture at a relatively low concentration.

More particularly, the present invention relates to membrane separation at relatively high recovery of Helium that is present in natural gas at a relatively low concentration.

2. Related Art

For relatively rare and/or costly gases, it is often desirable to recover them from natural or industrial sources where such gases are in admixture with other gases. A variety of separation technologies exist for separation of rare and/or costly gases from gas mixtures, including adsorption, such as pressure swing adsorption (PSA), and cryogenic distillation.

One separation technology, gas separation membranes, typically includes one or more compressors and one or more gas separation membranes arranged in parallel or series. A permeate is obtained on a side of the membrane opposite the side to which the feed gas is fed. The separation layer of the membrane preferentially permeates one gas or gases in comparison to another gas or gases so that the permeate becomes enriched in one or more components. The non-permeate is obtained from the same side of the membrane from which the feed gas is fed and consequently is deficient in the component or components of which the permeate is enriched. Selection of the particular material making up the separation layer is driven by which components in the feed gas are desired for enrichment in the permeate and which components in the feed gas are desired for enrichment in the non-permeate. While there are a wide variety of materials used in gas separation membranes, one type of commonly used material is glassy polymers.

One gas of particular interest for recovery is Helium which is only available at significantly high volumes from natural gas. Helium is typically present in natural gas at below 0.5 mol % levels and is mostly extracted as crude Helium across liquid natural gas (LNG) trains. This crude Helium, containing about 20-30 mol % Helium, is then enriched either by cryogenic distillation or via a PSA to make 99.9999 mol % Helium.

Small gas molecules such as Helium are well known to be more permeable through glassy polymer membranes than methane or N₂. Hence, membranes can be considered for Helium recovery from natural gas. However, Helium is typically found in very low concentrations and it is difficult for a single stage membrane to achieve commercially viable levels of recovery and/or selectivity.

In general, recovery of dilute components by membranes requires multiple stages in order to achieve high purity. Other mass transfer operations, such as distillation can produce high purities by means of multiple stages. Unfortunately, membrane processes are expensive to stage since each additional stage often involves permeate recompression with the attendant operating and capital costs of the compressor. In other words, the permeate from the first stage typically must be compressed to a satisfactory pressure for separation in the second stage and the permeate from the second stage similarly may need to be compressed before it is fed to the third stage. Each additional compressor increases the capital, and especially operating, expense of such a multi-stage scheme.

Methods of optimally staging membrane processes have been extensively studied in the academic literature in an effort to reach a desired recovery and/or purity. Examples of this work include Agarwal, et al., (“Gas separation membrane cascades II. Two-compressor cascades”, Journal of Membrane Science 112 (1996) 129-146) and Hao 2008 (“Upgrading low-quality natural gas with H₂S- and CO₂-selective polymer membranes Part II. Process design, economics, and sensitivity study of membrane stages with recycle streams”, Journal of Membrane Science 320 (2008) 108-122).

Staged membrane operations are also practiced commercially. An example is the well-known 2-stage process described by WO 12050816 A2. In this scheme, permeate from a first membrane stage (or from a section of a first membrane stage) of is re-compressed and processed by a second membrane stage. The second stage permeate is achieved at higher fast gas purity. The second stage residue is recycled to the first stage membrane feed.

Permeate refluxing is described in some versions of membrane column work by Tsuru, et al. (“Permeators and continuous membrane columns with retentate recycle”, Journal of Membrane Science 98 (1995) 57-67). In this context, permeate refluxing is practiced on a single membrane stage with refluxing of a fraction of the permeate, then re-compressing that fraction and recycling it to either the feed gas or as a sweep gas. This permeate refluxing scheme is not appropriate for handling a high volume gas as the membrane area required for combined high purity and high recovery is very high.

It is therefore an object of the invention to provide a method and system for membrane-based gas separation to obtain a satisfactorily high recovery of a first gas at a satisfactorily high purity from a source gas that includes a minor amount of the first gas and a majority of a second without sacrificing too much of the second gas. It is also an object of the invention to provide a method and system for membrane-based gas separation to obtain a satisfactorily high recovery of the first gas at a satisfactorily high purity from the source gas without requiring an undesirably high gas separation membrane surface area.

### SUMMARY

There is disclosed a method of recovering a first gas from a source gas comprising a minor amount of the first gas and a major amount of a second gas. The method includes the following steps. A first gas mixture is separated with a first gas separation membrane into a first permeate and a first non-permeate. The second gas mixture is separated at a second gas separation membrane into a second permeate and a second non-permeate. The second permeate is divided into first and second portions, wherein the first portion of the second permeate is a first product gas, a majority of which is the first gas, and the first non-permeate is a second product gas a majority of which is the second gas. The first permeate is compressed with the second portion with a compressor to thereby produce the second gas mixture. The second non-permeate and a source gas are combined to thereby produce the first gas mixture. The first gas preferentially permeates across the first and second gas separation membranes in comparison to the second gas.

The method may include one or both of the following aspects:

the source gas is natural gas, the first gas is methane, and the second gas is Helium.

Helium is present in the natural gas at a concentration of less than 0.5 mol %.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

The FIGURE is an elevation schematic view of the method and system for separating Helium from natural gas using three gas separation membrane stages.

### DESCRIPTION OF PREFERRED EMBODIMENTS

In the method and system according to the invention, first and second product gases made up of predominantly first and second gases, respectively, are obtained from a source gas. The source gas contains mostly the second gas and also includes the first gas at a relatively low concentration. A particular gas membrane separation scheme allows the first product gas to be obtained at a relatively high recovery and purity and the second product gas to be obtained at a satisfactory recovery.

As best illustrated by the FIG, a feed gas 1 is obtained from a source 3. The source comprises first and second gases with the first gas being present at a relatively low concentration and the second gas at a relatively high concentration.

While the source is not limited to a particular combination of first and second gas, the first gas must be present in the source at a significantly lower concentration than that of the second gas. Typically, the source includes X-Y% of the first gas and X-Y% of the second gas. Non-limiting examples of sources and paired first and second gases include: natural gas containing a minor amount of Helium and majority of methane, and electronics gases. Typically, the source is natural gas containing no more than 0.5% Helium and the balance hydrocarbons, mainly methane.

The feed gas 1 is combined with a non-permeate 5 from a second stage membrane 7 and fed to a first stage gas separation membrane 9. The gas mixture 11 formed from the combination of the feed gas 1 and the non-permeate 3 is separated by the first stage membrane 9 into a first permeate 13 and a first non-permeate 15. The polymeric material making up the separation layer of the first stage membrane 7 is selected such that the first gas preferentially permeates through the membrane 9 in comparison to the second gas. Under such conditions, the first gas is considered the “fast” gas and the second gas the “slow gas”.

The first permeate 13 is combined with a portion 17 of the permeate 19 from the second stage membrane 7. The gas mixture 21 formed from the combination of the first permeate 13 and the portion 17 of the second stage permeate 19 are compressed at a compressor 23 and fed to the second stage membrane 7. Similar to the first stage membrane 9, the polymeric material making up the separation layer of the second stage membrane 7 is selected such that the first gas preferentially permeates through the membrane 7 in comparison to the second gas. Typically, a same polymeric material is used in the separation layer of each of the first and second membrane stages 9, 7.

The second stage membrane 7 separates the gas mixture 21 into the second permeate 19 and the second non-permeate 5. A valve 25 is used to divide the second permeate 19 into a first portion 17 (for combination with the first permeate 13) and a second portion 27. The second portion 27 constitutes the first product gas and is enriched in the first gas. The first non-permeate 15, on the other hand, constitutes the second product gas and is mainly comprised of the second gas.

The first and second gas separation membranes may be configured in a variety of ways, such as a sheet, tube, or hollow fiber. One of ordinary skill in the art will recognize that the permeate “side” of a membrane does not necessarily mean one and only one side of a membrane. Rather, in the case of membranes made up of a plurality of hollow fibers, the permeate “side” actually is considered to be the plurality of sides of the individual hollow fibers that are opposite to the sides to which the relevant feed gas is introduced. Preferably, each of the gas separation membranes 3, 17, 23 is made up of a plurality of hollow fibers. In that case, the hollow fiber may be monolithic or it may include a sheath separation layer surrounding a core layer.

The material constituting the separation layer of the membranes is driven by the pair of first and second gases sought to be separated. Non-limiting examples of materials suitable for the separation layer in the membrane for a wide variety of gas pairs include polymers or copolymers such as polysulfones, polyether sulfones, polyimides, polyaramides, polyamide-imides, and blends thereof. Many suitable polymeric materials are described in US 2011/0247360 A1.

In the case of a source gas of natural gas containing Helium, a class of particularly suitable polymeric materials is described by WO 2009/087520 and includes the repeating units shown in the following formula (I):

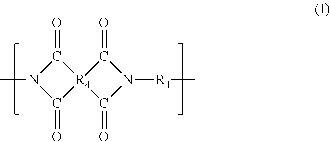

in which R₁ of formula (I) is a moiety having a composition selected from the group consisting of formula (A), formula (B), formula (C), and mixtures thereof, and

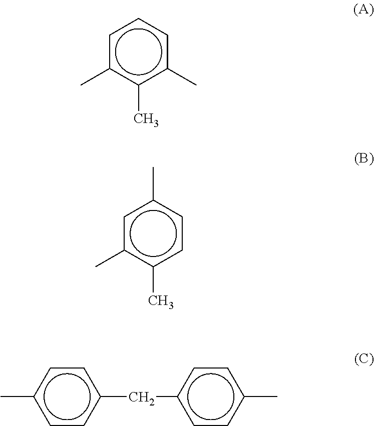

in which R₄ of formula (I) is a moiety having a composition selected from the group consisting of formula (Q), formula (S), formula (T) and mixtures thereof,

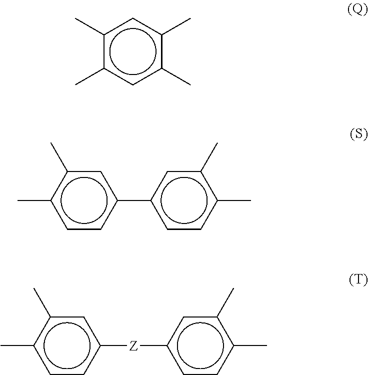

in which Z of formula (T) is a moiety selected from the group consisting of formula

(L), formula (M), formula (N) and mixtures thereof.

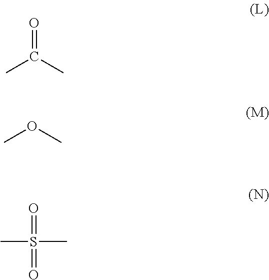

In one embodiment, a polyimide forming the selective layer of the membrane(s) has repeating units as shown in the following formula (Ia):

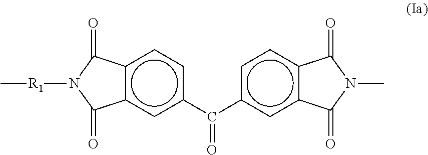

In this embodiment, moiety R₁ of formula (Ia) is of formula (A) in 0-100% of the repeating units, of formula (B) in 0-100% of the repeating units, and of formula (C) in a complementary amount totaling 100% of the repeating units. A polymer of this structure is available from HP Polymer GmbH under the trade name P84. P84 is believed to have repeating units according to formula (Ia) in which R₁ is formula (A) in about 16% of the repeating units, formula (B) in about 64% of the repeating units and formula (C) in about 20% of the repeating units. P84 is believed to be derived from the condensation reaction of benzophenone tetracarboxylic dianhydride (BTDA, 100 mole %), with a mixture of 2,4-toluene diisocyanate (2,4-TDI, 64 mole %), 2,6-toluene diisocyanate (2,6-TDI, 16 mole %) and 4,4′-methylene-bis(phenylisocyanate) (MDI, 20 mole %).

In another embodiment, the polyimide of the separation layer of the membrane(s) comprises repeating units of formula (Ib):

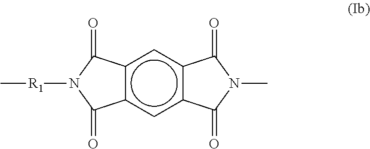

where R₁ of formula (Ib) is formula (A) in about 0-100% of the repeating units, and of formula (B) in a complementary amount totaling 100% of the repeating units. In yet another embodiment, a polyimide in the separation layer of the membrane(s) is a copolymer comprising repeating units of both formula (Ia) and (Ib) in which units of formula (Ib) constitute about 1-99% of the total repeating units of formulas (Ia) and (Ib). A polymer of this structure is available from HP Polymer GmbH under the trade name P84HT. P84HT is believed to have repeating units according to formulas (Ia) and (Ib) in which the moiety R₁ is a composition of formula (A) in about 20% of the repeating units and of formula (B) in about 80% of the repeating units, and, in which repeating units of formula (Ib) constitute about 40% of the total of repeating units of formulas (Ia) and (Ib). P84HT is believed to be derived from the condensation reaction of benzophenone tetracarboxylic dianhydride (BTDA, 60 mole %) and pyromellitic dianhydride (PMDA, 40 mole %) with 2,4-toluene diisocyanate (2,4-TDI, 80 mole %) and 2,6-toluene diisocyanate (2,6-TDI, 20 mole %).

The first stage membrane 9 acts as a stripper of the low concentration first gas and its membrane area is selected based upon a desired overall recovery of the first gas. The second stage membrane 7 acts as an enricher of the first gas and its membrane area is selected such that the concentration of the low concentration first gas in the second non-permeate 5 matches that of the feed gas 1.

The invention provides multiple advantages. First, varying the reflux ratio of the second permeate 19 can be used as a tool for controlling the overall recovery of the second gas. It can also be used as a tool for controlling the concentration of the first gas in the first product gas. While an increase in the reflux ratio will increase the required membrane area for the second stage membrane 7 as well as compressor costs, these effects are relatively small since the permeate streams are small.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A method of recovering a first gas from a source gas comprising a minor amount of the first gas and a major amount of a second gas, said method comprising the steps of:
separating a first gas mixture with a first gas separation membrane into a first permeate and a first non-permeate;
separating a second gas mixture at a second gas separation membrane into a second permeate and a second non-permeate, wherein the first gas preferentially permeates across the first and second gas separation membranes in comparison to the second gas;
dividing the second permeate into first and second portions, wherein the first portion of the second permeate is a first product gas, a majority of which is the first gas, and the first non-permeate is a second product gas a majority of which is the second gas;
compressing the first permeate with the second portion with a compressor to thereby produce the second gas mixture; and
combining the second non-permeate and a source gas to thereby produce the first gas mixture.

2. The method of claim 1, wherein the source gas is natural gas, the first gas is methane, and the second gas is Helium.

3. The method of claim 2, wherein Helium is present in the natural gas at a concentration of less than 0.5 mol %.
